(19) United States
(12) Patent Application Publication
(10) Pub. No.: US 2009/0268472 A1
(43) Pub. Date: Oct. 29, 2009

(54) DISPLAY DEVICE WITH REDUCED INTERFERENCE FRINGE EFFECT

(76) Inventors: Jong-Seong KIM, Seoul (KR); Woo-Jae LEE, Yongin-si (KR); Nan-Seok ROH, Seongnam-si (KR)

Correspondence Address: Haynes and Boone, LLP;IP Section, 2323 Victory Avenue, SUITE 700, Dallas, TX, 75219, US

(21) Appl. No.: 12/268,252

(22) Filed: Nov. 10, 2008

(30) Foreign Application Priority Data
Apr. 29, 2008 (KR) 10-2008-0039974

(51) Int. Cl. H05B 33/22

(52) U.S. Cl. 362/355

(57) ABSTRACT

A display device that is capable of reducing interference fringe such as a moiré pattern is presented. The display device comprises first and second substrates facing each other, each of the first and second substrates comprising fibers arranged in a lattice pattern, and a pixel layer formed between the first and second substrates. The fibers in the first substrate extend in a first direction and a second direction that is substantially perpendicular to the first direction, the fibers in the second substrate extend in a third direction and a fourth direction substantially perpendicular to the third direction, and the first direction and the third direction form an oblique angle.

### CROSS-REFERENCE TO RELATED APPLICATION

This application claims priority to and the benefit of Korean Patent Application No. 10-2008-0039974 filed in the Korean Intellectual Property Office on Apr. 29, 2008, the entire content of which is incorporated herein by reference.

### BACKGROUND OF THE INVENTION

(a) Field of the Invention

The present invention relates to a display device. More particularly, the present invention relates to a flexible display device.

(b) Description of the Related Art

Recently, flat panel display devices have experienced explosive popularity and their sales are growing quickly. A flat panel display is a display device that is thin relative to the size of the screen, and liquid crystal displays (LCDs) and an organic light emitting devices (OLEDs) are among some of the widely used flat panel displays.

Liquid crystal displays generally include an upper panel in which a common electrode and color filters are formed, a lower panel in which thin film transistors and pixel electrodes are formed, and a liquid crystal layer disposed between the two display panels. An electric field is generated when a potential difference is applied between the pixel electrode and the common electrode, and the direction of liquid crystal molecules is determined by the electric field. Since the transmittance of incident light depends on the arrangement and orientation of the liquid crystal molecules, desired images can be displayed by adjusting the potential difference between two electrodes.

Organic light emitting devices generally include a hole injection electrode (anode), an electron injection electrode (cathode), and an organic emission layer formed between the anode and the cathode, and it is a self-illuminating display device that emits light while holes injected from the anode and electrons injected from the cathode recombining and becoming extinct in the organic emission layer.

The display devices described above have limitations both in terms of their size and their portability because they adopt a glass substrate that is heavy and fragile. Therefore, a display device using a flexible plastic substrate that is light and impact-resistant as well as flexible has been recently developed.

Among these display devices that use plastic substrates, when a fiber reinforced plastic is used as the two substrates of a display device, a moiré pattern is generated by interference such that the display characteristics may be deteriorated. A method for reducing the moiré pattern is desired.

The above information disclosed in this Background section is only for enhancement of understanding of the background of the invention and therefore it may contain information that does not form the prior art that is already known in this country to a person of ordinary skill in the art.

### SUMMARY OF THE INVENTION

A display device according to an exemplary embodiment of the present invention comprises first and second substrates facing each other, wherein each of the first and second substrates comprises fibers arranged in a lattice pattern. A pixel layer is formed between the first and second substrates. n The fibers in the first substrate extend in a first direction and a second direction that is substantially perpendicular to the first direction, the fibers in the second substrate extend in a third direction and a fourth direction that is substantially perpendicular to the third direction, and the first direction and the third direction form an oblique angle.

At least one of an angle formed by the first direction and the third direction and an angle formed by the first direction and the fourth direction may be in the range of 1 to 89 degrees.

The pixel layer may comprise a scanning signal line formed on the first substrate and extending in a fifth direction, and a data line extending in a sixth direction that is substantially perpendicular to the fifth direction.

The fifth direction may form an oblique angle with at least one of the first direction and the third direction.

The fifth direction may form oblique angles with the first direction and the third direction.

At least one of an angle formed by the fifth direction and the first direction or an angle formed by the fifth direction and the third direction may be in the range of 1 to 89 degrees, or 91 to 179 degrees.

The first and second substrates may further comprise plastic.

The fiber may comprise glass fiber.

The plastic may comprise a thermosetting resin or a thermoplastic resin.

In another aspect, the invention is a display device that comprises a pixel layer and a first substrate formed on the pixel layer. The pixel layer comprises a scanning signal line extending in a first direction and a data line extending in a second direction that is substantially perpendicular to the first direction. The first substrate comprises fibers extending in a third direction and a fourth direction that is substantially perpendicular to the third direction to form a lattice pattern, and the first direction and the third direction form an oblique angle.

At least one of an angle formed by the first direction and the third direction or an angle formed by the first direction and the fourth direction may be in the range of 1 to 89 degrees.

A second substrate facing the first substrate with the pixel layer between the first and second substrates and comprising a fiber arranged in a lattice pattern may be further included.

The fiber of the second substrate may extend in a fifth direction and a sixth direction that is substantially perpendicular to the fifth direction, and the fifth direction may form an oblique angle with respect to the first direction or the third direction.

At least one angle between the fifth direction and the first direction and an angle between the fifth direction and the third direction may be in the range of 1 to 89 degrees, or 91 to 179 degrees.

In yet another aspect, the invention is a display device that comprises a first substrate comprising a fiber extending in a first direction, a second substrate comprising a fiber formed in a second direction, and a pixel layer formed between the first and second substrates, wherein the first direction and the second direction form an oblique angle.

An angle between the first direction and the second direction may be in the range of 1 to 179 degrees.

The pixel layer may comprise a scanning signal line that extends in a third direction and a data line extending in a fourth direction that is substantially perpendicular to the third direction, and the third direction may form an oblique angle with the first direction or the second direction.

### BRIEF DESCRIPTION OF THE DRAWINGS

FIG. 1 is a block diagram of a display device according to an exemplary embodiment of the present invention.

FIG. 2A and FIG. 2B are a cross-sectional view and a plan view of a fiber reinforced plastic comprised in a substrate of a display device according to an exemplary embodiment of the present invention, respectively.

FIG. 3 is a schematic exploded perspective view of a display device according to an exemplary embodiment of the present invention.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

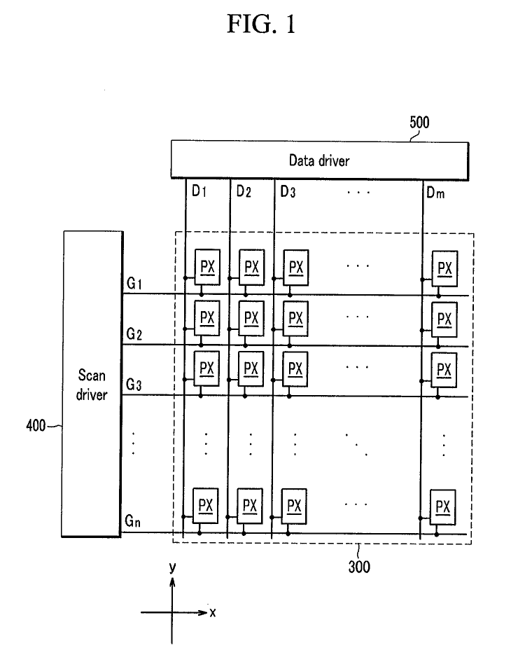

First, a display device according to an exemplary embodiment of the present invention will be described with reference to FIG. 1.

FIG. 1 is a block diagram of a display device according to an exemplary embodiment of the present invention.

Referring to FIG. 1, a display device according to an exemplary embodiment of the present invention includes a display panel 300, a scan driver 400, and a data driver 500.

The display panel 300 includes a plurality of signal lines G₁-Gₙ and D₁-Dₘ, and a plurality of pixels PX connected thereto and substantially arranged in a matrix.

The signal lines G₁-Gₙ and D₁-Dₘ include a plurality of scanning signal lines G₁-Gₙ for transmitting scanning signals and a plurality of data lines D₁-Dₘ for transmitting data voltages. The scanning signal lines G₁-Gₙ extend substantially in a transverse direction and substantially parallel to each other, and the data lines D₁-Dₘ extend substantially in a longitudinal direction and substantially parallel to each other.

Each pixel PX includes a switching element (not shown) such as a thin film transistor and an electro-optic converting element (not shown) for converting an electric signal to light. The pixels PX are applied with data voltages from the data lines D₁-Dₘ through the switching element (not shown) turned on according to a scanning signal from the scanning signal lines G₁-Gₙ, thereby displaying an image through the electro-optic converting elements (not shown). The electro-optic converting elements (not shown) may include a liquid crystal layer in the case of a liquid crystal display, and an organic light emitting member in the case of an organic light emitting device.

The scan driver 400 is connected to the scanning signal lines G₁-Gₙ, and applies scanning signals, which are combinations of a high voltage Von and a low voltage Voff, to the scanning signal lines G₁-Gₙ.

The data driver 500 is connected to the data lines D₁-Dₘ of the display panel 300 and applies data voltages corresponding to image signals to the data lines D₁-Dₘ.

Light does not pass through the region between a plurality of pixels that are arranged in a matrix, and the regions between the plurality of pixels form a lattice pattern with the scanning signal lines G₁-Gₙ and the data lines D₁-Dₘ in the display panel 300. Hereafter, as shown in FIG. 1, the transverse line direction of the lattice pattern of the display panel 300 is referred to as an x-axis direction, and the longitudinal line direction is referred to as a y-axis direction.

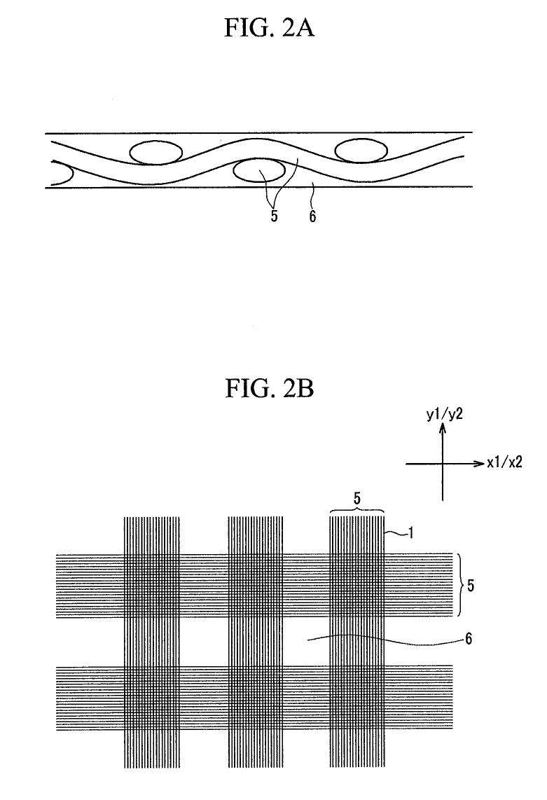

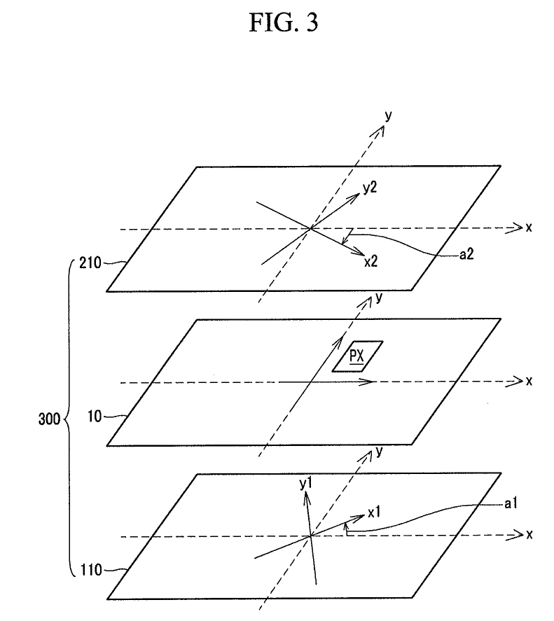

Next, a display panel 300 of a display device according to an exemplary embodiment of the present invention will be described in detail with reference to FIG. 2A, FIG. 2B, and FIG. 3 as well as FIG. 1.

FIG. 2A and FIG. 2B are a cross-sectional view and a plan view of a fiber reinforced plastic embedded in a substrate of a display device according to an exemplary embodiment of the present invention, respectively, and FIG. 3 is a schematic exploded perspective view of a display device according to an exemplary embodiment of the present invention.

Referring to FIG. 3, the display panel 300 of the display device according to an exemplary embodiment of the present invention includes lower and upper substrates 110 and 210, and a pixel layer 10 interposed between the substrates 110 and 210 in a structural view.

The lower substrate 110 and the upper substrate 210 include a fiber reinforced plastic (FRP).

As shown in FIG. 2A and FIG. 2B, the fiber reinforced plastic according to an exemplary embodiment of the present invention includes a plurality of fiber bundles 5 that are formed in two directions substantially perpendicular to each other, and a resin 6 impregnated between the fiber bundles 5. Here, the word “perpendicular to” is used to include the case where two corresponding directions meet each other substantially at a right angle. As shown in FIG. 2B, the fiber bundle 5 includes at least one fiber 1. In some embodiments, the fiber bundle 5 may include only one fiber 1. The fiber 1 may be a transparent glass fiber, a carbon fiber, an aramid fiber, or a nylon fiber, and the resin 6 may be a thermosetting resin such as polyester and epoxy, or a thermoplastic resin. Hereinafter, the two substantially perpendicular directions in which the fiber bundles 5 in the lower substrate 110 extend will be referred to as an x1-axis direction and a y1-axis direction, and the two substantially perpendicular directions in which the fiber bundles 5 in the upper substrate 210 extend will be respectively referred to as an x2-axis direction and a y2-axis direction.

In one embodiment, the fiber bundles 5 of the substrates 110 and 210 may all extend in the same direction.

Referring to FIG. 1 and FIG. 3, the pixel layer 10 includes a plurality of scanning signal lines G₁-Gₙ formed in the x-axis direction, a plurality of data lines D₁-Dₘ formed in the y-axis direction, and a plurality of pixels PX disposed between the lattice pattern formed by the scanning signal lines G₁-Gₙ and the data lines D₁-Dₘ and arranged in a matrix.

Each pixel PX includes a switching element (not shown) and an electro-optic converting element (not shown) as described above.

The x1-axis and the y1-axis along which the fiber bundles 5 in the lower substrate 110 extend respectively form an oblique angle a1 in a counterclockwise direction with respect to the x-axis and the y-axis of the pixel layer 10. The x2 axis and the y2 axis along which the fiber bundles 5 in the upper substrate 210 extend respectively form an oblique angle a2 in a clockwise direction with respect to the x-axis and the y-axis of the pixel layer 10. Also, the x1-axis and the y1-axis along which the fiber bundles 5 in the lower substrate 110 extend respectively form an oblique angle a1+a2 with respect to the x2-axis and the y2-axis along which the fiber bundles 5 of the upper substrate 210 extend.

Alternatively, the x1-axis and the y1-axis may respectively form an oblique angle a1 in a clockwise direction with respect to the x-axis and the y-axis, and the x2-axis and the y2-axis may respectively form an oblique angle a2 in a counterclockwise direction with respect to the x-axis and the y-axis.

In yet another alternative embodiment, each of the lower and upper substrates 110, 210 may respectively form oblique angles a1, a2 with respect to the x-axis and the y-axis in the same direction.

Here, the oblique angle a1 between the x1-axis and the x-axis, the oblique angle a2 between the x2-axis and the x-axis, and the oblique angle a1+a2 between the x1-axis and the x2-axis may respectively be in the range of 1 degree to 89 degrees, or 91 degrees to 179 degrees.

In the invention, the lower substrate 110, the upper substrate 210, and the pixel layer 10, each of which includes a lattice pattern, are disposed such that the lattice patterns make oblique angles with each other, thereby preventing generation of an interference fringe such as a moiré pattern. When lattice patterns make oblique angles with respect to each other, it includes both the case where the two x-directions make an oblique angle with respect to each other and the case where the x-direction in one lattice pattern makes an oblique angle with respect to the y-direction in the other lattice pattern.

In another embodiment, the lattice patterns of two among the lower substrate 110, the pixel layer 10, and the upper substrate 210 may make an oblique angle with each other. For example, the x1-axis and the x-axis may form an oblique angle a1, the x2-axis and the x-axis may form an oblique angle a2, or the x1-axis and the x2-axis may form an oblique angle. Here, each of the oblique angles a1 and a2 may be in the range of 1 degree to 89 degrees, or 91 degrees to 179 degrees.

In yet another embodiment, the upper substrate 210 may be omitted. In this case, the lattice pattern of the pixel layer 10 and the lattice pattern of the lower substrate 110 may form an oblique angle with each other, thereby preventing an interference fringe.

In yet another embodiment, the lower and upper substrates 110 and 210 have fiber bundles 5 that extend in one direction (as opposed to making a lattice pattern). In this case, the fiber bundles 5 of the two substrates 110 and 210 may form an oblique angle with respect to each other, or the directions of the fiber bundles 5 of the two substrates 110 and 210 may form oblique angles with respect to the lattice pattern of the pixel layer 10.

According to the present invention, generation of an interference fringe such as a moiré pattern can be prevented, thereby improving the characteristics of the display device.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. The display device comprising:
first and second substrates facing each other, each of the first and second substrates comprising fibers arranged in a lattice pattern; and
a pixel layer formed between the first and second substrates,
wherein the fibers in the first substrate extend in a first direction and a second direction that is substantially perpendicular to the first direction,
the fibers in the second substrate extend in a third direction and a fourth direction that is substantially perpendicular to the third direction, and
the first direction and the third direction form an oblique angle.

2. The display device of claim 1, wherein
At least one of an angle formed by the first direction and the third direction and an angle formed by the first direction and the fourth direction is in the range of 1 to 89 degrees.

3. The display device of claim 1, wherein
the pixel layer comprises
a scanning signal line formed on the first substrate and extending in a fifth direction, and
a data line extending in a sixth direction substantially perpendicular to the fifth direction.

4. The display device of claim 3, wherein
the fifth direction forms an oblique angle with at least one of the first direction and the third direction.

5. The display device of claim 4, wherein
the fifth direction forms oblique angles with the first direction and the third direction.

6. The display device of claim 4, wherein
at least one of an angle formed by the fifth direction and the first direction and an angle formed by the fifth direction and the third direction is in the range of 1 to 89 degrees, or 91 to 179 degrees.

7. The display device of claim 1, wherein
the first and second substrates further comprise plastic.

8. The display device of claim 7, wherein
the fiber comprises glass fiber.

9. The display device of claim 7, wherein
the plastic comprises a thermosetting resin or a thermoplastic resin.

10. A display device comprising:
a pixel layer comprising a scanning signal line extending in a first direction and a data line extending in a second direction substantially perpendicular to the first direction; and
a first substrate formed on the pixel layer, the first substrate comprising fibers extending in a third direction and a fourth direction that is substantially perpendicular to the third direction to form a lattice pattern, wherein the first direction and the third direction form an oblique angle.

11. The display device of claim 10, wherein
at least one of an angle formed by the first direction and the third direction and an angle formed by the first direction and the fourth direction is in the range of 1 to 89 degrees.

12. The display device of claim 10, further comprising
a second substrate facing the first substrate with the pixel layer between the first and second substrates and comprising fibers arranged in a lattice pattern.

13. The display device of claim 12, wherein:
the fiber of the second substrate extend in a fifth direction and a sixth direction that is substantially perpendicular to the fifth direction, and
the fifth direction forms an oblique angle with respect to the first direction or the third direction.

14. The display device of claim 13, wherein
at least one of an angle between the fifth direction and the first direction and an angle between the fifth direction and the third direction is in the range of 1 to 89 degrees, or 91 to 179 degrees.

15. A display device comprising:
a first substrate comprising a fiber extending in a first direction;
a second substrate comprising a fiber extending in a second direction; and
a pixel layer formed between the first and second substrates,
wherein the first direction and the second direction form an oblique angle.

16. The display device of claim 15, wherein
an angle between the first direction and the second direction is in the range of 1 to 179 degrees.

17. The display device of claim 15, wherein:
the pixel layer comprises a scanning signal line extending in a third direction and a data line extending in a fourth direction that is substantially perpendicular to the third direction, and
the third direction forms an oblique angle with respect to the first direction or the second direction.
